(19) United States
(12) Patent Application Publication
(10) Pub. No.: US 2025/0175410 A1
(43) Pub. Date: May 29, 2025

(54) METHODS, ARCHITECTURES, APPARATUSES AND SYSTEMS FOR ENABLING WIRELESS RELIABILITY AND AVAILABILITY IN MULTI-DOMAIN DEPLOYMENTS

(71) Applicant: InterDigital Patent Holdings, Inc., Wilmington, DE (US)

(72) Inventors: Carlos Jesus Bernardos, Madrid (ES); Alain Mourad, Ascot (GB)

(21) Appl. No.: 18/841,914

(22) PCT Filed: Mar. 3, 2023
(86) PCT No.: PCT/US2023/014507

§ 371 Date: Aug. 27, 2024

(30) Foreign Application Priority Data
Mar. 4, 2022 (EP) 22160335.0

(51) Int. Cl. H04L 45/02; H04L 5/00; H04L 43/0852; H04L 45/302

(52) U.S. Cl. CPC H04L 45/04; H04L 5/0053; H04L 43/0852; H04L 45/302

(57) ABSTRACT

Procedures, methods, architectures, apparatuses, systems, devices, and computer program products directed to enabling wireless reliability and availability in multi-domain deployments are described herein. In an embodiment, a network element may be configured to send, to a first network element of a first domain network, a first request message requesting one or more tracks towards a second domain network, the first request message indicating a requested quality of service (QoS). The network element may be configured to receive, from the first network element, a response message indicating (i) one or more second network elements of the second domain network interconnecting the first domain network with the second domain network, and (ii) a QoS partitioning of the requested QoS to be applied on the first and the second domain networks.

### CROSS-REFERENCE TO RELATED APPLICATIONS

This application claims priority to European Patent Application No. 22160335.0, filed Mar. 4, 2022, which is incorporated herein by reference in its entirety.

### TECHNICAL FIELD

The present disclosure is generally directed to the fields of communications, software and encoding, including, for example, methods, architectures, apparatuses, and systems directed to enabling wireless reliability and availability in multi-domain deployments.

### BACKGROUND

Wireless may operate on a shared medium. Wireless transmissions may not be deterministic due to uncontrolled interferences, including, for example, self-induced multipath fading. Embodiments described herein have been designed with the foregoing in mind.

### BRIEF SUMMARY

Methods, architectures, apparatuses, and systems directed to enabling wireless reliability and availability in multi-domain deployments are described herein. In an embodiment, a network element including a processor and a transmitter and a receiver (e.g., a transceiver) operatively coupled to the processor is described herein. For example, the processor may be configured to send, to a first network element of a first domain network, a first request message requesting one or more tracks towards a second domain network, the first request message indicating a requested quality of service (QoS). For example, the processor may be configured to receive, from the first network element, a response message indicating (i) one or more second network elements of the second domain network interconnecting the first domain network with the second domain network, and (ii) a QoS partitioning of the requested QoS to be applied on the first and the second domain networks. For example, the processor may be configured to send to the one or more second network elements of the second domain network, one or more second request messages requesting to set up a communication channel across the first and the second domain networks, the one or more second request messages indicating the QoS partitioning to be monitored on the first and the second domain networks via the communication channel. For example, the processor may be configured to receive from the one or more second network elements of the second domain network, an acknowledgement indicating that the communication channel has been established.

In an embodiment, a method may be implemented in a network element. For example, the method may comprise sending to a first network element of a first domain network, a first request message requesting one or more tracks towards a second domain network, the first request message indicating a requested QoS. For example, the method may further comprise receiving, from the first network element, a response message indicating (i) one or more second network elements of the second domain network interconnecting the first domain network with the second domain network, and (ii) a QoS partitioning of the requested QoS to be applied on the first and the second domain networks. For example, the method may further comprise sending to the one or more second network elements of the second domain network, one or more second request messages requesting to set up a communication channel across the first and the second domain networks, the one or more second request messages indicating the QoS partitioning to be monitored on the first and the second domain networks via the communication channel. For example, the method may further comprise receiving from the one or more second network elements of the second domain network, an acknowledgement indicating that the communication channel has been established.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of communication involving two reliable and available wireless (RAW) domains, interconnected by a core network;

FIG. 3 is a diagram illustrating an example of multi-domain awareness and connectivity setup;

FIG. 4 is a diagram illustrating an example of RAW domain aware link setup;

FIG. 5 is a diagram illustrating an example of multi-domain RAW signaling flow;

FIG. 6 is a diagram illustrating an example of communication involving two RAW domains, interconnected by a wireless network, and

FIG. 7 is a diagram illustrating an example of a multi-domain RAW communication method.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

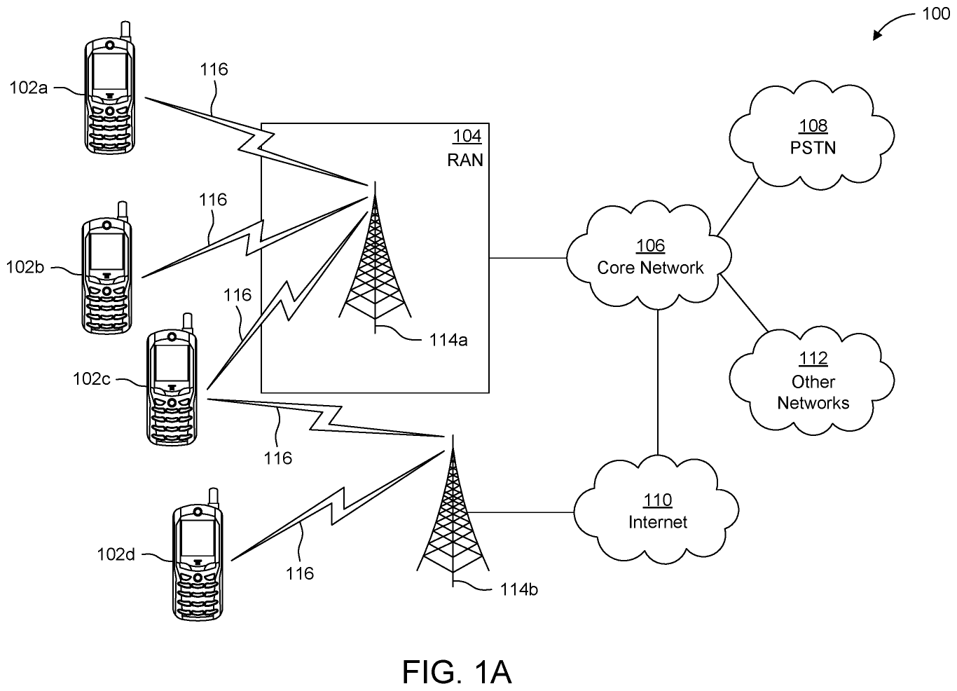

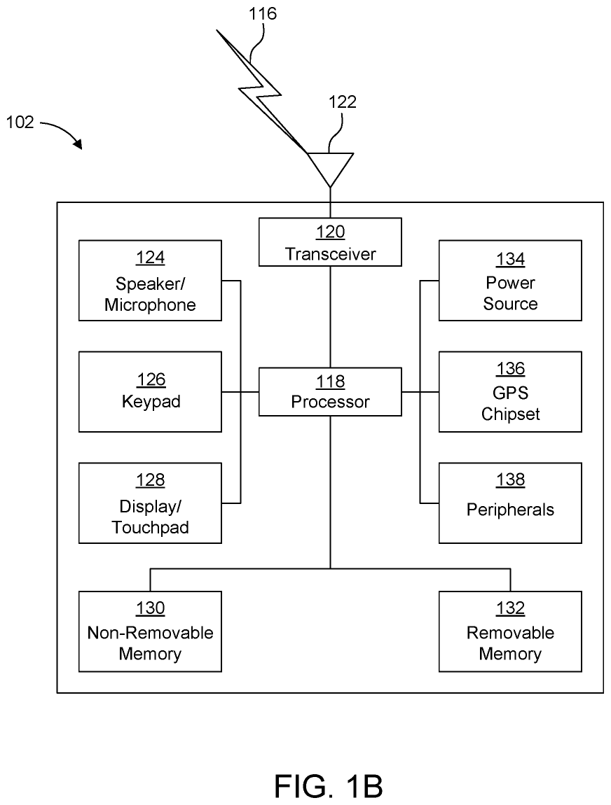

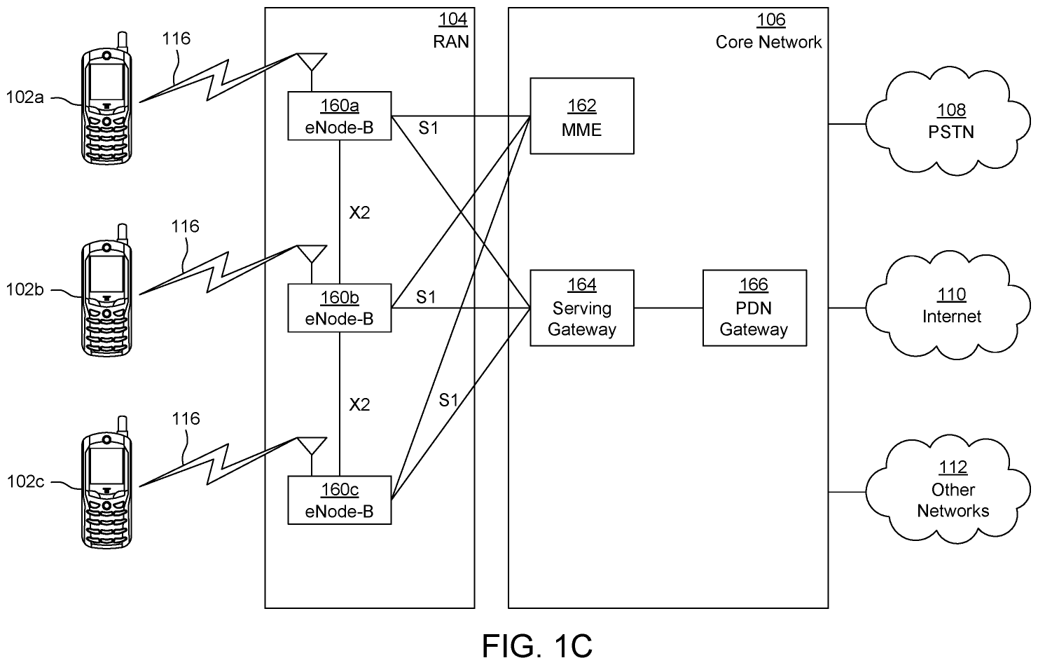

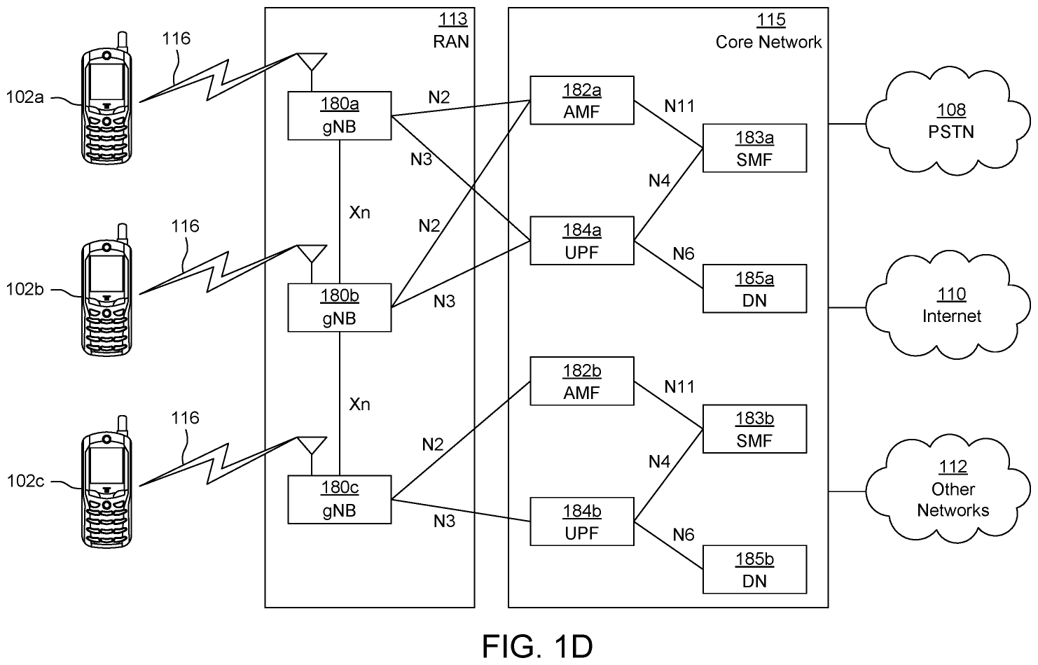

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein, (e.g., configuration) information may be described as received by a network element (e.g., WTRU) from the network, for example, through system information or via any kind of protocol message. Although not explicitly mentioned throughout embodiments described herein, the same (e.g., configuration) information may be pre-configured in the network element (e.g., WTRU) e.g., via any kind of pre-configuration methods such as e.g., via factory settings, such that this (e.g., configuration) information may be used by the network element (e.g., WTRU) without being received from the network.

### Example of Reliable and Available Wireless

For example, based on any of time, resource reservation, and policy enforcement by distributed shapers, deterministic networking may provide the capability to carry any of unicast and multicast data streams for real-time applications with any of low data loss rates and bounded latency, such that any of time-sensitive and mission-critical applications may be supported e.g., on a converged enterprise infrastructure.

Wireless may operate on a shared medium. Wireless transmissions may not be deterministic due to uncontrolled interferences, including, for example, self-induced multipath fading. Internet Engineering Task Force (IETF) reliable and available wireless (RAW) may be seen as a system aiming at providing deterministic networking across a path that may include a wireless element. For example, RAW may be seen as a system providing high reliability and availability for IP connectivity over a wireless medium. The wireless medium may present challenges to achieve (e.g., obtain, deliver) deterministic properties such as any of low packet error rate, bounded consecutive losses, and bounded latency. RAW may be seen as extending the system described by IETF DetNet working group to provide for any of high reliability and availability for an IP network utilizing any of (e.g., scheduled) wireless segments and other media, e.g., frequency/time-sharing physical media resources with stochastic traffic such as e.g., any of IEEE Std. 802.15.4 time slotted channel hopping (TSCH), 3GPP 5G ultra-reliable low latency communications (URLLC), IEEE 802.11ax/be, and L-band digital aeronautical communications system (LDACS), etc. Similar to DetNet, RAW technologies may be seen as staying abstract to the radio layers underneath, addressing the layer three aspects in support of applications associated with high reliability and availability.

A RAW architecture is described in “Reliable and Available Wireless Architecture/Framework,” draft-ietf-raw-architecture-02, November 2021. RAW may be seen as distinguishing between longer and shorter forwarding time scales, where the longer time scale may be used for routes computation and the shorter time scale which is used for per-packet forwarding decisions. For example, RAW may operate within the network plane at the forwarding time scale on one (e.g., deterministic network) flow over a path that may be referred to herein as a “track”. A track may comprise one or more network segments (e.g., which may be referred to herein as hops). For example, a track may be pre-established and configured by means that may be independent from the RAW system. For example, a track may be any of strict and loose depending on whether each hop or (e.g., only) a subset of the hops may be any of monitored and controlled by the RAW system.

Embodiments described herein are not limited to (e.g., IETF) RAW networks. Any network capable of ensuring reliability and availability, such as e.g., any network capable of providing deterministic networking may be applicable to embodiments described herein. Any network element with reliability and availability capability may be referred to herein as a RAW network element.

Throughout embodiments described herein the terms “quality of service (QoS)”, “QoS metric(s)”, “SLA”, “SLA level” may be used interchangeably to refer to one or more metrics representative of a quality (e.g., property) of a network (e.g., segment), including without limitation any of a (e.g., bounded) latency, a (e.g., guaranteed) bandwidth (e.g., throughput), an availability metric, a (e.g., bounded) reliability (e.g., loss) metric.

For example, a RAW system may be structured as an “observe, orient, decide, act” OODA loop. For example, a RAW system may comprise network plane measurement protocols for network management such as e.g., operations, administration and maintenance (OAM) to observe properties (e.g., characteristics) of any of one or more hops along a track and the end-to-end packet delivery. For example, a RAW system may further comprise controller plane elements that may be configured to report (e.g., send information indicating) the links statistics to a path computation element (PCE) in a centralized controller that may compute and install (e.g., determine) the tracks and may provide meta data to orient (e.g., assist) the routing decision. For example, a RAW system may further comprise a runtime distributed path selection engine (PSE) that may determine which sub-track to use for the next packet(s) that may be routed along the track. For example, a RAW system may further comprise packet (hybrid) automatic repeat request (ARQ), replication, elimination and ordering data-plane actions that may operate at the DetNet service layer to increase the reliability of the end-to-end transmission. A RAW system may (e.g., also) comprise (e.g., in-situ) signaling in a case where a decision is made by a node that may be on the path down the track from the PSE.

For example, the overall OODA loop may allow to improve the use of redundancy to obtain an expected reliability and availability service level agreement (SLA) and to reduce the use of (e.g., constrained) resources such as spectrum and battery.

For example, RAW may be seen as distinguishing (e.g., separating) the path computation time scale at which a (e.g., complex) path (e.g., a track) may be recomputed from the path selection time scale at which the forwarding decision may be taken for one or more packets. For example, a RAW system may operate at the path selection time scale. For example, a RAW system may decide (e.g., determine, select) amongst the redundant solutions that may be proposed (e.g., indicated) by the path computation element (PCE), which one may be used for a (e.g., each) packet to provide a reliable and available service while reducing the use of constrained resources. For example, the RAW system may comprise one or more PSE(s) that may be seen as the counterpart of the PCE to perform rapid local adjustments of the forwarding tables within the diversity that the PCE may have selected for the track. For example, the PSE may allow to exploit (e.g., use) the richer forwarding capabilities with any of packet (hybrid) ARQ, replication, elimination and ordering (PAREO), and scheduled transmissions at a faster time scale.

Throughout embodiments described herein, a network element comprising (e.g., running) a PCE function may be referred to herein as a “PCE”. Throughout embodiments described herein, a network element comprising (e.g., running) a PSE function may be referred to herein as a “PSE”. For the sake of clarity, embodiments are described herein using path computation network elements and path selection network elements. Embodiments described herein are not limited to any of path computation network elements and path selection network elements and are applicable to any kind of network elements.

Throughout embodiments described herein, partitioning a (e.g., requested) QoS in two partitions (e.g., that may be different) may be referred to herein as splitting the (e.g., requested) QoS in a first QoS split and a second QoS split. Throughout embodiments described herein the terms “first/second QoS split” may be used interchangeably with “first/second QoS budget” and “first/second QoS partition” to refer to any split/partition/budget of a (e.g., requested) QoS (e.g., target, objective).

### RAW Terminology

For example, a track may comprise a networking graph that may be followed to transport packet(s) with a same treatment (e.g., processing). For example, although a path may be linear, a track may not be linear. For example, a track may comprise one or more (e.g., linear) paths that may e.g., fork and rejoin, for instance to enable the RAW PAREO operations.

In embodiments described herein a track may have the following properties.

For example, a track may comprise one ingress node and one egress node, which may operate as e.g., DetNet edge nodes.

For example, a track may be reversible, e.g., packets may be routed against the flow of data packets, e.g., to carry network management information such as any of OAM measurements and control messages that may be transmitted back to the ingress node.

For example, the vertices of the track may comprise the functionalities of DetNet relay nodes that may operate at the DetNet service sublayer and may provide the PAREO functions.

For example, the topological edges of the graph may comprise one or more serial sequences of DetNet transit nodes that may operate at the DetNet forwarding sublayer.

For example, a sub-track may comprise a (e.g., part of a) track within a track. For example, a RAW PSE may select a sub-track on any of a per-packet basis and a per-collection of packets basis to provide an (e.g., expected, requested) reliability (e.g., QoS) for the transported flow(s).

### Overview

For example, in the manufacturing sector, a (e.g., large) set of devices may be interconnected and may generate data that they may expect to be reliably delivered to the control and monitoring agents. In another example, in the residential gaming domain, extended reality (XR) applications may expect data to be reliably delivered between various pieces of equipment.

A domain that may be managed by a single PCE may be referred to herein as “single-domain RAW”, where e.g., nodes may be run and managed by a single administration entity (e.g., network element). In single-domain RAW example, a PSE may make use of tracks and paths involving (e.g., only) the nodes belonging to this RAW domain.

There may be examples, where WTRUs may be connected to different RAW domains and may communicate with a level of any of reliability and availability (e.g., guarantee), for example, in large factories where networks may be organized in domains (per production lines or building/sites), in residential environments where there may be different networks (e.g., one at home and one in the garden), or in vehicular examples (e.g., WTRUs connected to different vehicles).

Throughout embodiments described herein the terms “RAW domain”, “RAW domain network” and “domain network” may be used interchangeably to refer to a network of network elements that may be managed by an entity for providing a set of functionalities (such as e.g., RAW) between the network elements.

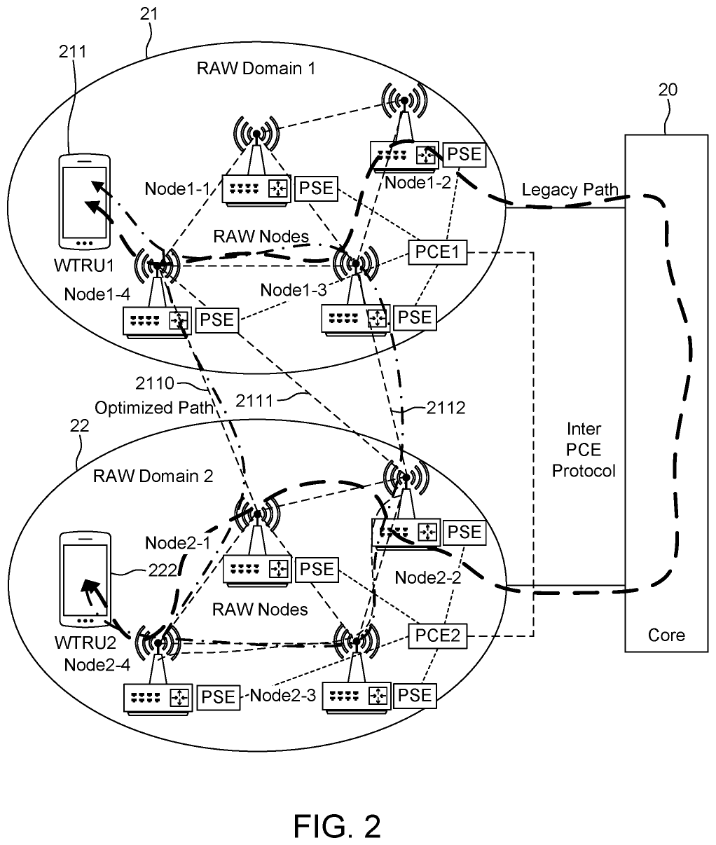

FIG. 2 is a diagram illustrating an example of communication involving two RAW domains 21, 22, interconnected by a core network 20 (such as e.g., 5G core). For example, a first WTRU 211 may be connected to a first RAW domain 21 and a second WTRU 222 may be connected to a second RAW domain 22. In the illustrated multi-domain example, the first WTRU 211 may communicate with the second WTRU 222 across core network 20. A multi-domain example may be different from a single-domain example, where a single PCE may compute the tracks at longer time scale, and the PSE may perform sub-track selection and improvement at a shorter time scale using information available at the RAW domain. Embodiments described herein may allow WTRUs 211, 222 connected to different RAW domains 21, 22 to communicate with a level of any of reliability and availability (e.g., guarantee).

For example, neighboring RAW domains 21, 22 may not be (e.g., directly) connected, and may communicate via (e.g., non DetNet-capable) network segments (e.g., network segments which may not provide deterministic networking). Without a deterministic (e.g., DetNet/RAW) end-to-end path, any type of reliability and availability may not be provided. Embodiments described herein may allow to provide on demand and dynamically inter-domain reliable and available links.

For example, in a case where different RAW domains 21, 22 have links 2110, 2111, 2112 connecting them, the RAW domains 21, 22 may operate independently of each other. For example, inter-PCE methods may allow the PCE of one RAW domain to learn some inter-domain paths. In such an example, the PSE of one RAW domain 21 may not have full visibility of the other RAW domains 22 and may not be capable to act on the other RAW domains due to a lack of multi-domain OAM mechanisms, limiting its capability to guarantee any SLA. Embodiments described herein may allow to enable inter-PSE coordination mechanisms across RAW domains.

For example, a multi (e.g., inter)-domain path may be determined (e.g., computed) based on the hierarchical PCE (G-PCE) described in IETF RFC 6805. For example, a parent PCE may maintain a domain topology map that may include the child domains (represented by vertices in the topology) and their interconnections (represented by links in the topology). The parent PCE may have no information about the content of the child domains. For example, the parent PCE may have no information about the resource availability within the child domains, and no information about the availability of connectivity across the domains for preserving the confidentiality of the information across the domains. The parent PCE may be used to compute a multi-domain path based on the domain connectivity information. A child PCE may be responsible for one or more domains and may be used to compute the intra-domain path based on its (e.g., own) domain topology information. For example, a G-PCE operation may comprise a path computation client (PCC) sending inter-domain path computation request (PCReq) messages (as described in IETF RFC 5440) to the child PCE responsible for (e.g., managing) its domain. For example, a G-PCE operation may comprise the child PCE forwarding the request to the parent PCE. For example, a G-PCE operation may comprise the parent PCE computing (e.g., determining) the (e.g., candidate) domain paths from the ingress domain to the egress domain. For example, a G-PCE operation may comprise the parent PCE sending the intra-domain PCReq messages (between the domain border nodes) to the child PCEs that may be responsible for (e.g., managing) the domains along the domain path. For example, a G-PCE operation may comprise the child PCEs returning information describing the intra-domain paths to the parent PCE. For example, a G-PCE operation may comprise the parent PCE constructing the end-to-end inter-domain path based on the intra-domain paths. For example, a G-PCE operation may comprise the parent PCE returning information describing the inter-domain path to the child PCE. For example, a G-PCE operation may comprise the child PCE forwarding the information describing the inter-domain path to the PCC.

Mechanisms based on IETF G-PCE may not allow RAW applications to benefit from any of reliability and availability properties in a multi-RAW domain environment. Embodiments described herein may allow to provide any of reliability and availability in a multi-domain wireless heterogeneous mesh network by allowing additional information sensitive (e.g., reflecting, reactive) to transient changes to be exchanged between PSEs of one or more RAW domains.

Within a single RAW domain system, the PCE may be in charge of determining (e.g., computing) the paths (e.g., tracks) and the PSE(s) may take the shorter time decisions of which sub-tracks to use. For example, the PSE may be running as any of a distributed functionality (performed by the different RAW routers of the path, which may take forwarding decisions based on the local and any available OAM information), and a centralized functionality performed by the entry (ingress) router in the domain which may perform source routing. In a case where there are multiple ingress nodes, there may be multiple PSEs.

In examples with multiple connected RAW domains, running uncoordinated RAW in the domains may not allow RAW applications to benefit from any of reliability and availability properties. Embodiments described herein may allow the PSEs of multiple RAW domains to have, for example, global end-to-end information. Embodiments described herein may allow the PSEs of multiple RAW domains to be capable of, for example, running OAM mechanisms to monitor the quality of the selected paths. Throughout embodiments described herein, and without limitation, OAM mechanisms are used to describe the mechanisms by which any QoS metric of any data flow (e.g., stream, service, application) may be monitored and by which any network parameter impacting the monitored QoS metric may be changed (e.g., updated, adjusted). Any network management mechanism (e.g., protocol, framework), may be applicable to embodiments described herein.

Embodiments described herein may allow to enable coordination between network elements of multiple RAW domains, in different ways. For example:

Embodiments described herein may allow a PSE of a RAW domain to learn about (e.g., receive information indicating) PSEs of other neighboring RAW domains to any of connect to and coordinate with.

Embodiments described herein may allow to any of set up and release on-demand the coordination links between PSEs of different RAW domains.

Embodiments described herein may allow to any of set-up and release on-demand cross-domain RAW paths, for example, in such a way that any (e.g., involved) PSE may take actions to provide (e.g., guarantee) an expected (e.g., requested) reliability and availability. The actions may include, for example, a (e.g., new) inter-PSE interface (e.g., set of messages) to facilitate (e.g., enable) any of a division (e.g., split) of OAM performances and a rapid notification of changes for enabling a reaction at impacted RAW domains.

A (e.g., new) RAW specific inter-PCE and inter-PSE interactions (e.g., set of messages to be exchanged between PCEs and PSEs of different RAW domains) are described herein. These interactions (e.g., messages) may enable different RAW domains to connect and coordinate together, by allowing to distribute actions (e.g., processing) among the different network elements (PCEs and PSEs of the different RAW domains). These interactions (e.g., messages and associated processing) may allow to (i) enable (e.g., direct) inter-domain connectivity, benefitting from PAREO operations between the RAW domains (e.g., beyond a single RAW domain); (ii) coordinate the RAW operations at a RAW domain, by distributing OAM functions between the RAW domains, such that dynamical adjustment through the new inter-PSE interface may be enabled. Embodiments described herein may allow to mitigate the drawbacks of keeping the RAW domains isolated and uncoordinated, based on the inter-PSE communications described herein.

### Example of Multi-Domain Awareness and Inter-Domain Link(s) Setup

Methods to enable a RAW domain to any of detect, identify and register other neighboring RAW domains are described herein. For example, cross-domain RAW communications may be based on one or more links interconnecting the RAW domains. Throughout embodiments described herein, the term “link” is used to designate any kind of network connection capable of connecting two network elements respectively belonging to two different RAW domains. A (e.g., connecting) network element may be a PSE or any kind of other network element. For example, the links may be pre-configured (e.g., in industrial environments). In another example, (e.g., any of residential network, vehicular network), link(s) may be set up based on on-demand mechanism. Mechanisms for on-demand setup of links between RAW domains are described herein.

For example, RAW domains may be aware of their (e.g., respective) existence and may anticipate (e.g., detect) changes in the connectivity. For example, a RAW domain may exchange (e.g., any of send and receive) information associated with a RAW domain and describing (e.g., indicating) the RAW domain for learning about other RAW domains. Information describing (e.g., indicating) a RAW domain may include any of the following examples (e.g., of information item(s), indication(s)).

In an example, information describing (e.g., indicating) a RAW domain may include a first identifier (which may be referred to herein as RAW-PSE-ID) associated with a PSE and allowing to identify a PSE network element.

In another example, information describing (e.g., indicating) a RAW domain may include a second identifier (which may be referred to herein as RAW-domain-ID) associated with a RAW domain and allowing to identify a RAW domain among other RAW domains. RAW-domain-ID may allow to learn (e.g., indicate) which neighboring RAW domains may be reachable to distinguish them from other (e.g., not reachable RAW domains).

In yet another example, information describing (e.g., indicating) a RAW domain may include RAW-domain-prefix(es), indicating one or more IP prefix of nodes (e.g., network elements), that may be reachable at this RAW domain.

In yet another example, information describing (e.g., indicating) a RAW domain may include any of an (e.g., IP) address and an interface uniform resource identifier (URI) of the PCE of the RAW domain, which may be referred to herein as RAW-domain-PCE.

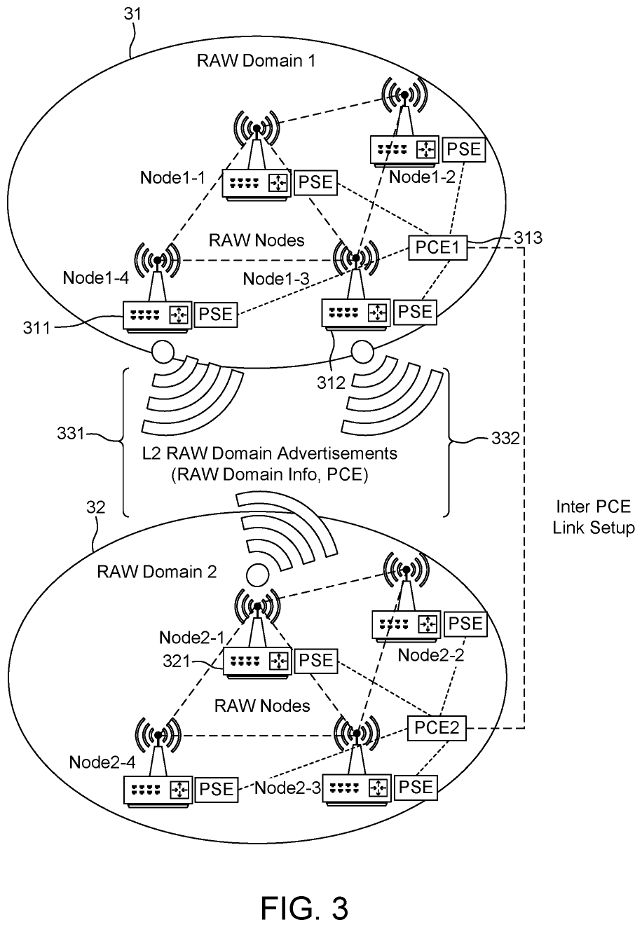

FIG. 3 is a diagram illustrating an example of multi-domain awareness and connectivity setup. For example, a first RAW domain 31 may be in the range of a second RAW domain 32. More precisely, the first RAW domain 31 may comprise one or more first network elements 311, 312 that may be in the range of one or more second network elements 321 of the second RAW domain 32. For example, the first RAW domain 31 may comprise a path computation network element 313 that may be in the range or not in the range of the second RAW domain 32. For example, there may be different methods for discovering the RAW domains, which may be described as follows.

In a first example, a first RAW domain 31 may discover a second RAW domain 32 based on catalogues. For example, RAW domain operators may publish (e.g., send) and may keep (e.g., sending) updated information indicating the RAW domains in catalogues that may be accessed by other (e.g., authorized) RAW domains. Any technique for populating and hosting the catalogues (such as e.g., domain name system (DNS), any of public and private blockchains) may be applicable to embodiments described herein. For example, a first network element 311, 312, of a first RAW domain 31 may send first information indicating the first RAW domain as described herein to a second network element 321 of a second RAW domain 32, that may be in the range 331 of the first network element 311, 312. For example, the first network element 311, 312, may receive second information indicating the second RAW domain as described herein from a second network element 321 of the second RAW domain, that may be in the range 331 of the first network element 311, 312.

In a second example, a first RAW domain 31 may discover a second RAW domain 32 based on out of band signaling over (e.g., established) links 332. For example, links 332 may have already been configured between RAW network elements belonging to different RAW domains. For example, links 332 may be used to exchange RAW domain information. Any protocol capable to exchange information indicating a RAW domain, may be applicable to embodiments described herein such as, without limitation, any of border gateway protocol link-state (BGP-LS), and other routing protocols such as e.g., Internet control message protocol (ICMP), etc.

In a third example, a first RAW domain 31 may discover a second RAW domain 32 based on RAN-based advertisements 331. For example, in a case where no links are pre-established, (e.g., L2) advertisements may be used to piggyback (e.g., send/receive) the RAW domain information (e.g., using IEEE 802.11 beacons access network query protocol (ANQP)). Information indicating the RAW domains may allow to establish on-demand inter-domain links and update its status near real-time (e.g., by supporting prediction based on L2 measurements, e.g., any of signal level, and movement predictions). For example, some RAN L2 signaling mechanisms (e.g., messages) may include RAW domain information (e.g., indicating a RAW domain) and may be used by network elements (such as e.g., PSE(s)) at the boundaries of the RAW domain to any of advertise this RAW domain information, and monitor information broadcast/shared by PSE(s) from neighboring RAW domains.

### Example of Signaling for Inter-Domain Link(s) Setup

Methods to enable a RAW domain in the radio coverage of another RAW domain to set-up on-demand inter-domain links to enable coordination across the two RAW domains are described herein.

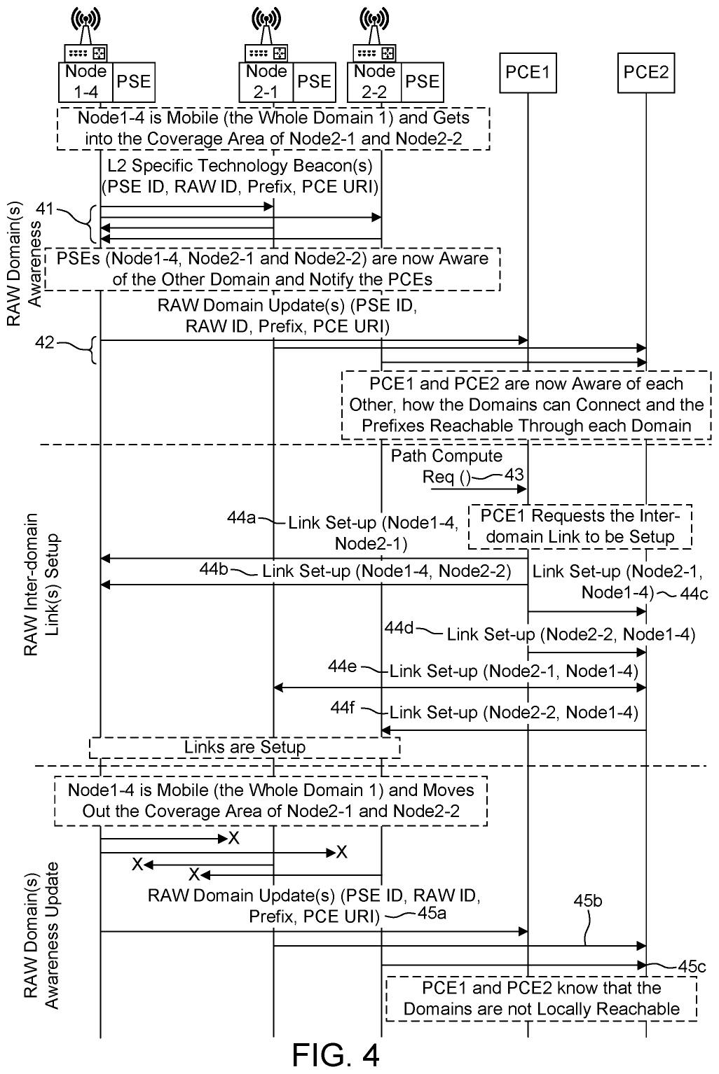

FIG. 4 is a diagram illustrating an example of RAW domain aware link setup. FIG. 4 illustrates an example of operation and signaling where RAW domain awareness, RAW inter-domain link setup and RAW domain awareness updates are described.

For example, a first RAW domain, which may be referred to herein as “domain1”, may be mobile. Embodiments described herein may (e.g., also) be applicable to stationary RAW domains. For example, the first RAW domain may get (e.g., enter) into the radio coverage of a second RAW domain, which may be referred to herein as “domain2”. For example, a first node of domain1 (that may be referred to herein as “node1-4”) may get into the radio coverage of one or more second nodes of domain2 that may be referred to herein as node2-1 and node2-2. For example, one or more layer two (L2) messages 41 may be periodically (e.g., repeatedly) exchanged (e.g., via broadcast). For example, L2 messages 41 may include RAW information indicating any of a PSE ID, a RAW domain ID, an IP prefix and a PCE address (e.g., URI). Any variation of this procedure, where, for example, (e.g., only) one parameter may be exchanged via a L2 message and additional means (e.g., messages, protocols) may be used to obtain (e.g., exchange) the additional information (e.g., to reduce the overall overhead), may be applicable to embodiments described herein.

For example, after reception of the one or more L2 messages 41, the PSEs that may be in radio coverage (node1-4, node2-1 and node2-2) may become aware of the presence of other PSEs from different RAW domains. For example, a PSE of a RAW domain may notify this to the PCE of its RAW domain. For example, one or more PSEs (e.g., node1-4, node2-1, node2-2) of the respective RAW domains may send information 42 to the PCE of their RAW domain to indicate a presence of network elements (PSEs) of other RAW domains in the radio coverage. For example, based on this information 42 the PCE of the first RAW domain (which may be referred to herein as PCE1) and the PCE of the second RAW domain (which may be referred to herein as PCE2) may be aware of the existence of PSEs, between which one or more links may be set-up for interconnecting their RAW domains.

For example, domain1 and domain2 may be aware of each other and may know which boundary PSEs may establish one or more links to interconnect the RAW domains. For example, a path computation request message 43 may be received by PCE1, indicating a request to set up one or more paths (e.g., tracks) between a network element in domain1 and an IP prefix (e.g., one or more IP address) that may be associated with domain2. A reception of such a path computation request message 43 may indicate to PCE1 that the other endpoint may be located at domain2 and that domain1 may be locally interconnected (e.g., over the wireless network) with domain2. For example, PCE1 may perform the procedures to set up link(s) interconnecting domain1 with domain2.

For example, PCE1 may send one or more link set-up messages 44a, 44b to one or more PSEs of domain 1, requesting the links to be set-up. For example, one or more link set-up messages 44a, 44b may include information indicating any of (i) a first link to be set up between node1-4 of domain1 and a node2-1 of domain2, and (ii) a second link to be set up between node1-4 of domain1 and a node2-2 of domain2. For example, PCE1 may send similar messages 44c, 44d to PCE2 to request the same links to be set up by the endpoints at domain2. For example, PCE1 may send one or more link set-up messages 44c, 44d to PCE2 of domain2, including information indicating any of (i) a first link to be set up between node1-4 of domain1 and a node2-1 of domain2, and (ii) a second link to be set up between node1-4 of domain1 and a node2-2 of domain2. For example, PCE2 may send one or more link set up messages 44e, 44f to one or more PSEs(s) at domain2, where the one or more link set up messages 44e, 44f may include information indicating any of (i) a first link to be set up between node1-4 of domain1 and a node2-1 of domain2, and (ii) a second link to be set up between node1-4 of domain1 and a node2-2 of domain2. The exchange of the link set-up messages 44a, 44b, 44c, 44d, 44e, 44f may allow the links to be set up between the network elements of the different RAW domains.

For example, (e.g., after the link set-up message exchange) domain1 and domain2 may be interconnected e.g., by a first link and a second link, and methods to set up an inter-domain connection may be performed as described herein.

In a case where the first RAW domain (domain1) moves out of the coverage of the second RAW domain (domain2), or in a case where obstacles temporarily prevent the connectivity, the boundary PSE(s) may detect an absence of connectivity between the first and the second RAW domains. For example, any of the boundary PSE(s) may notify (e.g., send information 45a, 45b, 45c indicating an absence of connectivity between the RAW domains) to the respective PCEs, which may know that there may not be any available local connectivity any more between the RAW domains.

For example, a loss of connectivity may be predicted before it may happen based on e.g., any of artificial intelligence and machine learning (AI/ML) algorithms to improve reliability and availability.

### Example of Multi-Domain RAW Connection Setup

Mechanisms and signaling extensions to enable inter-domain RAW connectivity are described herein. For example, inter-domain link setup procedures may have already been performed as indicated in embodiments described herein. An interface between the PSEs of two RAW domains, to enable computation of any of inter-domain paths, tracks, sub-tracks and support coordinated OAM across the two RAW domains are described herein.

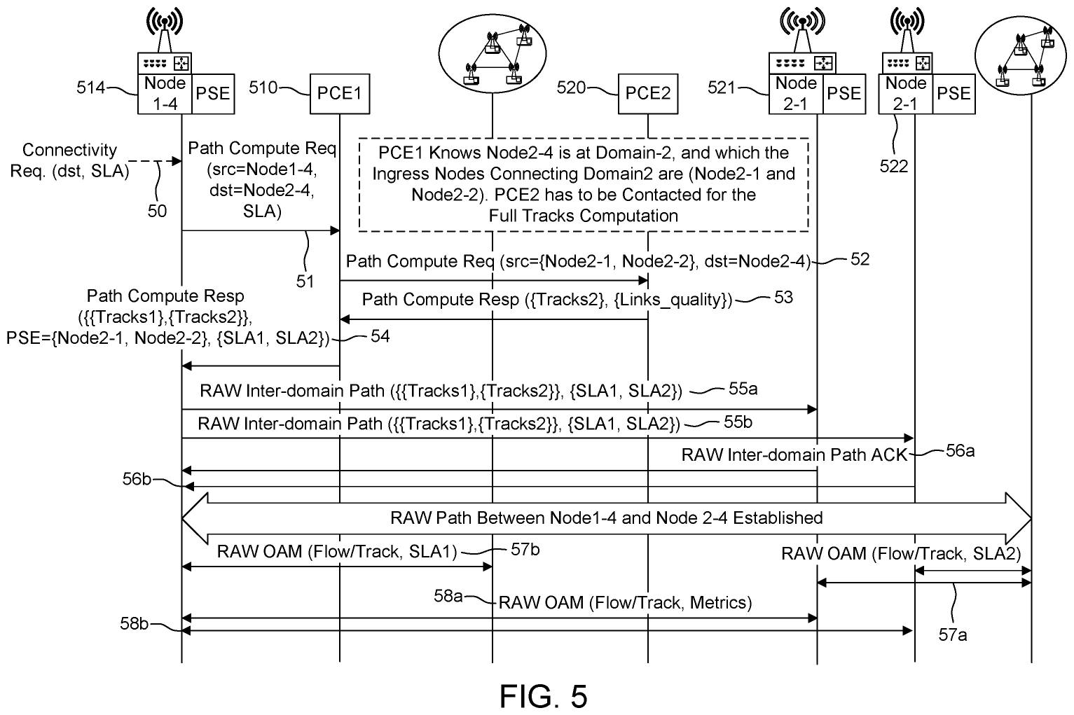

FIG. 5 is a diagram illustrating an example of multi-domain RAW signaling flow, for example, based on the example illustrated in FIG. 2 (e.g., where a first WTRU, that may be connected to a first RAW network element 514 (which may be referred to herein as node1-4) of the first RAW domain may establish communication with a second WTRU connected to a second RAW network element 521 (which may be referred to herein as node 2-1) of the second RAW domain.

For example, an ingress RAW network element 514 (e.g., node1-4) may receive an initial request message 50 comprising information indicating a request for connectivity, with a (e.g., given) destination RAW network element 521 (e.g., node2-1) and a requested QoS (e.g., SLA), e.g., in terms of reliability and availability. For example, the information may indicate a destination address (e.g., of any of the destination WTRU and a destination RAW network element to which the destination WTRU may be connected). For example, the information may further indicate a QoS (e.g., SLA), that may be requested for the connection with the destination WTRU. For example, any of the source and destination RAW network elements may be WTRU(s). For example, any of the source and destination WTRU may be a RAW network element.

For example, an ingress RAW network element 514 (e.g., node1-4) of domain1, may operate as a PSE (which may be referred to herein as PSE@domain1) and may send a first request message 51 to the PCE 510 of domain1 (which may be referred to herein as PCE1) for requesting (e.g., the computation, the determination of) one or more tracks towards the destination RAW network element 521 (to which the destination WTRU may be connected) with the requested QoS (e.g., SLA). For example, the first request message 51 may comprise information indicating any of (i) a source RAW network element (that may indicate any of an IP address and an identifier of the ingress RAW network element 514), a destination RAW network element (that may indicate any of an IP address and an identifier of the destination RAW network element, e.g., to which the destination WTRU may be connected), and a requested QoS (e.g., SLA). For example, the requested QoS (e.g., SLA) may be indicated by one or more values (e.g., levels) of one or more QoS metrics, such as any of a (e.g., bounded) latency, a (e.g., guaranteed) bandwidth, a (e.g., bounded) jitter, a (e.g., bounded) reliability ratio (e.g., any of a (e.g., packet) error rate and a (e.g., packet) loss ratio), a (e.g., guaranteed) availability ratio etc. For example, the destination RAW network element may be determined by the ingress RAW network element 514 based on the RAW domain prefix(es) indicated in the RAW domain information (describing domain2) that may have been received from domain2. In another example, (not illustrated), the ingress RAW network element 514 may not receive an initial request message 50 from the WTRU and may receive one or more packets directed to the destination RAW network element 521 (e.g., node2-1), which may trigger the transmission of the first request message 51 for requesting the one or more tracks towards the destination RAW network element 521 (e.g., node2-1).

For example, PCE1 510 may know (e.g., based on the RAW domain awareness method previously described) that the destination may be in another domain (domain2) and that the PCE 520 of the destination domain may be PCE2. For example, PCE1 510 may know (e.g., store information indicating) one or more (e.g., ingress) RAW network elements 521, 522 in domain2 that may be connected to domain1 (e.g., based on information collected via the RAW domain awareness method). For example, the one or more (e.g., ingress) RAW network elements 521, 522 (e.g., node2-1 and node2-2) may operate as PSEs@domain2. For example, PCE1 510 may send a request message 52 to PCE2 520 to request (e.g., computation, determination of) the available tracks (e.g., in domain2, which may be referred to herein as tracks2) from PSEs@domain2 to the destination, and the characteristics of the links (e.g., link_quality) forming these tracks. Any type of information that may be provided by PCE2 520 regarding the links allowing any of PCE1 510 and the PSE@domain1 (e.g., node1-4) to compute (e.g., determine) how to distribute the SLA among the RAW domains may be applicable to embodiments described herein.

For example, PCE2 520 may determine (e.g., compute) one or more tracks in domain2 (which may be referred to herein as tracks2) and may respond to PCE1 510, by sending a response message 53 to PCE1 510 including information indicating the characteristics of the links (e.g., link_quality). For example, the information indicating the characteristics of the links (e.g., link_quality) may include one or more indications of any of an available bandwidth, an observed reliability, a delay, a link variability a link mobility, etc. For example, the response message 53 may further comprise information indicating the one or more tracks in domain2 (tracks2).

For example, PCE1 510 may provide the PSE@domain1 with any of the tracks to reach the destination and a split of QoS (e.g., SLAs) between domain1 and domain2 (which may be referred to herein as SLA1 and SLA2). For example, PCE1 510 may determine one or more tracks in domain1, which may be referred to herein as tracks1, which may be used, in combination with tracks2 in domain2 to reach the destination. For example, the ingress RAW network element 514 of domain1 may receive, from PCE1 510, a response message 54 comprising information indicating any of (i) the one or more tracks (e.g., any of tracks1 and tracks2), (ii) one or more PSEs 521, 522 of the second RAW domain (e.g., PSEs@domain2) interconnecting the first RAW domain with the second RAW domain, and (iii) a first QoS split and a second QoS split to be applied respectively on the first and the second RAW domains.

For example, any of an SLA and a QoS (e.g., figure, metric) may include, as an example, and without limitation, any of: (i) a bounded (e.g., maximum) delay, such as e.g., a bounded latency, (ii) a guaranteed bandwidth (e.g., data rate, throughput), (iii) a bounded (e.g., maximum) jitter, such as e.g., a bounded jitter (e.g., packet delay variation), (iv) a (e.g., bounded) reliability ratio (e.g., any of a (e.g., packet) error rate, a (e.g., packet) loss ratio), and (v) an availability ratio, etc.

For example, a requested QoS (e.g., SLA) may be split in a first QoS split (e.g., SLA1) and a second QoS split (e.g., SLA2) such that the requested QoS may be determined to be satisfied between the source network element and the destination network element on condition that the first QoS split is satisfied on the first domain network and on condition that the second QoS split is satisfied on the second domain network. Non-limiting examples of the split of an SLA/QoS may include any of the following examples.

In an example, for QoS associated with 10 ms of bounded delay and 99.99 availability, a first QoS split (SLA1) may be associated with 6 ms of bounded delay and 99.999 availability, and a second QoS split (SLA2) may be associated with 3 ms of bounded delay and 99.999 availability.

In another example, for QoS associated with 10 ms of bounded delay and 1 Mbps of guaranteed bandwidth, a first QoS split (SLA1) may be associated with 5 ms of bounded delay and 2 Mbps of guaranteed bandwidth, and a second QoS split (SLA2) may be associated with 5 ms of bounded delay and 5 Mbps of guaranteed bandwidth SLA.

More generally, any example of a QoS comprising (e.g., associated with) a set of metrics (e.g., criteria to be satisfied) that may be split in a first QoS split and a second QoS split, where the first and the second QoS split may comprise (e.g., be associated with) a set of corresponding sub metrics (e.g., sub-criteria to be satisfied), may be applicable to embodiments described herein.

For example, PSE@domain1 514 may send one or more second request messages 55a, 55b to respectively the one or more PSEs 521, 522 of the second RAW domain (e.g., PSEs@domain2). The one or more second request messages 55a, 55b may (e.g., indicate a) request to set-up one or more (e.g., direct) communication channels e.g., to provide (e.g., for carrying) network management (e.g., OAM) information to be used by the PSE@domain1 514 for determining (e.g., computing) the sub-tracks to be used for the (e.g., data) traffic. The one or more (e.g., direct) communication channels may be any kind of connection(s) (e.g., session(s)) that may be established between two PSEs over which they may exchange network management (e.g., OAM) information to monitor (e.g., and guarantee) a QoS (e.g., SLA). For example, the one or more second request messages 55a, 55b may comprise information indicating the first QoS split (SLA1) and the second QoS split (SLA2) to be respectively monitored (e.g., and guaranteed) on (e.g., by the network elements of) the corresponding RAW domains (e.g., domain1, domain2). For example, the one or more second request messages 55a, 55b may comprise further information indicating the one or more tracks (e.g., any of tracks1, tracks2) of any of domain1 and domain2.

For example, the one or more PSEs@domain2 521, 522 may acknowledge the one or more second request messages 55a, 55b, for example, by sending an acknowledge message 56a, 56b (e.g., comprising information indicating an acknowledgement of the one or more second request messages 55a, 55b). For example, after the acknowledge message 56a, 56b reception, the communication channel (e.g., for carrying network management information) may be established and the PSE@domain1 514 may operate as a PSE (e.g., may start taking decisions at a forwarding time scale) regarding which paths (sub-tracks) to use (e.g., in domain1).

For example, the PSEs, at domain1 and domain2, may perform network management (e.g., OAM) procedures, as for example described in the IETF draft “Operations, Administration and Maintenance (OAM) features for RAW”, draft-ietf-raw-oam-support-02, June 2021. Any kind of network management framework able to monitor (e.g., determine) whether a monitored QoS (e.g., SLA) is meeting (e.g., satisfying) a requested QoS (e.g., SLA, SLA1, SL2), and to apply corrective operations (e.g., perform sub-track selection, adapt any of the sub-tracks and the tracks) may be applicable to embodiments described herein. For example, network management (e.g., OAM) mechanisms may be applied in-band (sharing the traffic's fate) or out of band. For example, PSE@domain1 may exchange network management messages 57b with one or more other PSEs@domain1 associated with (e.g., involved in) the tracks of domain1 (e.g., tracks1), to monitor the QoS of tracks1 to determine whether the monitored QoS is meeting (e.g., satisfying) the requested first QoS split (e.g., SLA1), and to apply any corrective operation (e.g., perform sub-track selection, adapt any of the sub-tracks and the tracks) such that the requested first QoS split (e.g., SLA1) may be obtained (e.g., provided). Similarly, PSEs@domain2 may exchange network management messages 57a to monitor the QoS on the tracks of domain2 (e.g., tracks2) to determine whether the monitored QoS is meeting (e.g., satisfying) the requested second QoS split (e.g., SLA2), and to apply any corrective operation (e.g., perform sub-track selection, adapt any of the sub-tracks and the tracks) such that the requested second QoS split (e.g., SLA2) may be obtained (e.g., provided). Embodiments described herein may allow to perform per-domain distributed OAM such that the requested QoS/SLAs, (e.g., reliability and availability) may be met (e.g., obtained, satisfied) by reacting on a shorter time scale at any of the involved RAW domains.

For example, PSEs may share any of aggregated and pre-processed information among them, to facilitate early detection of issues and computation (e.g., selection) of sub-tracks. In a case where a violation of an SLA is detected by a PSE, the PSE may notify any of the domain PCE and the other PSEs (e.g., of the other domain), such that a reaction measure (e.g., corrective operation) may be performed. Examples of reaction measures (e.g., corrective operations) may include any of selecting different sub-tracks, taking different PAREO decisions, requesting the PCEs (of any of domain1 and domain2) to recompute the paths and/or adjust the split of the QoS (e.g., SLAs) across the domains. For example, in a case where the first (respectively second) QoS split is not met on the first (respectively second) domain network, a message may be sent to any of PCE1 (respectively PCE2) and the one or more PSEs of the second (respectively first) domain network for requesting the tracks to be recomputed and/or the split of the requested QoS (e.g., SLA) to be adjusted. For example, PSE@domain1 and PSEs@domain2 may exchange network management messages 58a, 58b over the communication link. For example, the network management messages 58a, 58b may comprise information indicating any of a QoS (e.g., metric) to be monitored, a monitored QoS and a requested corrective operation).

In a first example, the paths between WTRU1 and WTRU2 may be bidirectional, and the mechanisms described herein may be applicable in both directions (WTRU1 to WTRU2 and WTRU2 to WTRU1). In a second example, the paths may not be bidirectional, and the mechanisms described herein for the WTRU1 to WTRU2 direction may be repeated to cover the WTRU2 to WTRU1 direction.

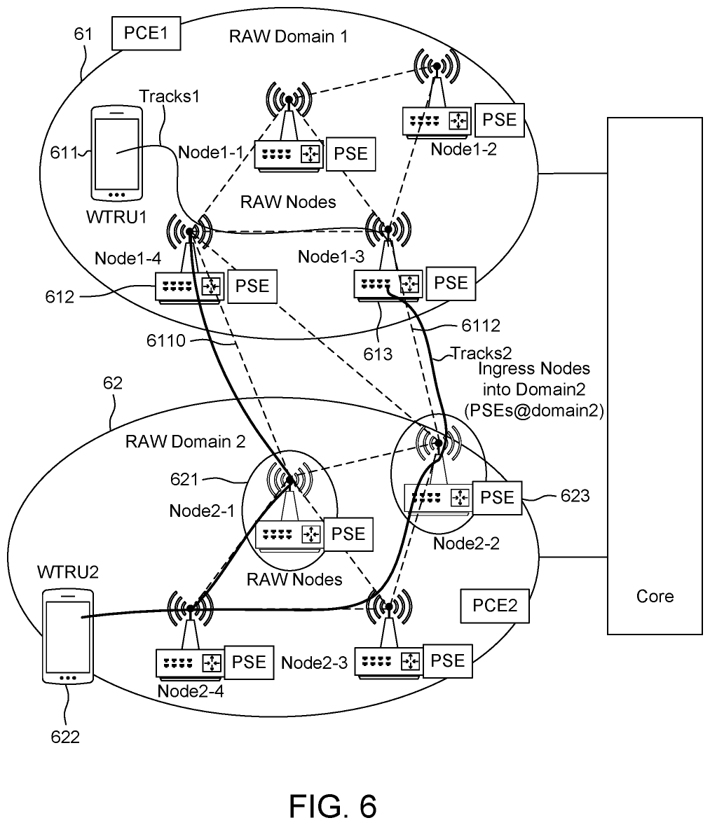

FIG. 6 is a diagram illustrating an example of communication involving two RAW domains 61, 62, interconnected by a wireless network. A first WTRU 611 of a first RAW domain 61 may communicate with a second WTRU 622 of a second RAW domain 62. The first 61 and the second 61 RAW domains may be interconnected by any of two interconnecting paths and two interconnecting links 6110, 6112 that may interconnect two PSEs 612, 613 of the first domain 61 to respectively two PSEs 621, 623 of the second domain 62. For example, any of the paths and the communications links 6110 and 6112 between the first 61 and the second 62 domains may be included in any of tracks1 and tracks2, e.g., for the purpose of network management (e.g., OAM) for monitoring whether the monitored QoS is meeting (e.g., satisfying) any of the requested first QoS split (e.g., SLA1) and the requested second QoS split (e.g., SLA2).

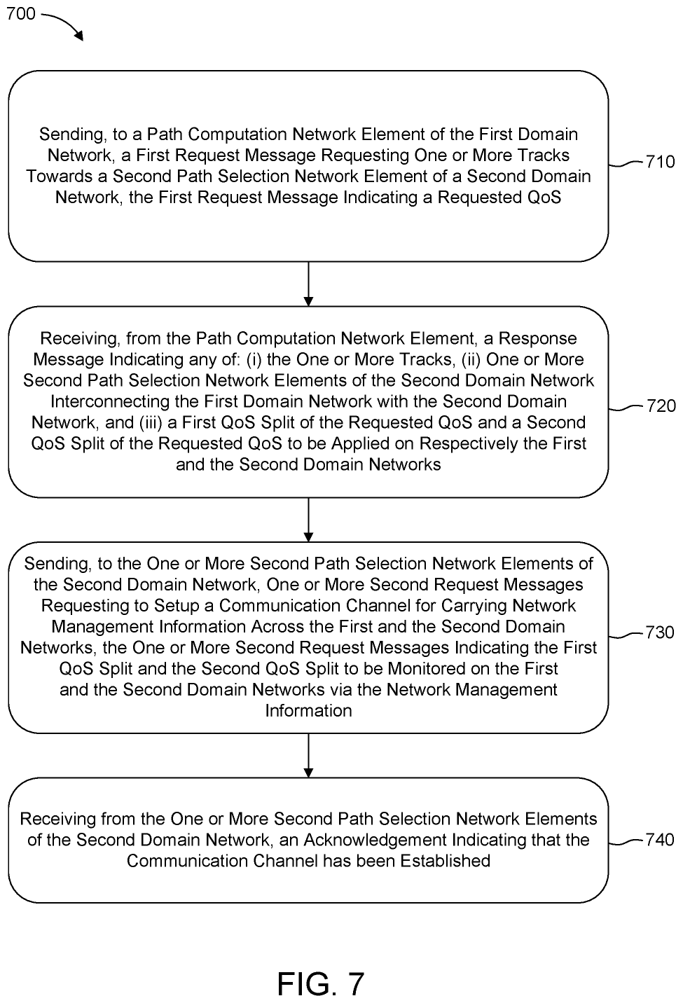

FIG. 7 is a diagram illustrating an example of a multi-domain RAW communication method 700. For example, the method may be implemented in a first path selection network element (PSE1) of a first domain network. For example, in step 710, the PSE1 may send to a path computation network element (PCE1) of the first domain network, a first request message requesting one or more tracks towards (e.g., a second path selection network element (PSE2s) of) a second domain network, the first request message indicating a requested QoS. For example, in step 720, the PSE1 may receive, from the PCE1, a response message indicating any of: (i) the one or more tracks, (ii) one or more second path selection network element (PSE2s) of the second domain network interconnecting the first domain network with the second domain network, and (iii) a first QoS split of the requested QoS and a second QoS split of the requested QoS to be applied on respectively the first and the second domain networks. For example, in step 730, the PSE1 may send, to the one or more PSE2s of the second domain network, one or more second request messages requesting to set up a communication channel (e.g., for carrying network management information) across the first and the second domain networks, the one or more second request messages indicating the first QoS split and the second QoS split to be monitored on the first and the second domain networks via the network management information (e.g., the communication channel). For example, in step 740, the PSE1 may receive from the one or more PSE2s of the second domain network, an acknowledgement indicating that the communication channel has been established.

For example, the requested QoS may be split in the first QoS split and the second QoS split such that the requested QoS may be satisfied (e.g., between the first path selection network element and the second path selection network element) on condition that the first QoS split is satisfied on the first domain network and on condition that the second QoS split is satisfied on the second domain network.

For example, any of the requested QoS, the first QoS split and the second QoS split may comprise at least one QoS metric indicating any of a bounded latency, a guaranteed bandwidth, a bounded jitter, a bounded reliability ratio, and an availability ratio.

For example, the PSE1 may receive one or more first network management messages comprising the network management information to monitor a first QoS of a first part of the one or more tracks associated with the first domain network.

For example, the PSE1 may adapt any of sub-tracks and tracks of the first part of the one or more tracks based on the received network management information, wherein any of the sub-tracks and the tracks may be adapted such that the monitored first QoS may satisfy the first QoS split.

For example, the PSE1 may receive one or more second network management messages from the one or more second path selection network elements of the second domain network, wherein the one or more second network management messages may comprise the network management information to monitor a second QoS of a second part of the one or more tracks associated with the second domain network.

For example, the one or more second network management messages may be received on the communication channel that may have been established.

For example, the PSE1 may adapt any of sub-tracks and tracks of the second part of the one or more tracks based on the received network management information, wherein any of the sub-tracks and the tracks may be adapted such that the monitored second QoS may satisfy the second QoS split.

For example, prior to sending the first request message, the PSE1 may receive an initial request message from a first WTRU of the first domain network, wherein the initial request message may comprise information requesting connectivity with a second WTRU of the second domain network at the requested QoS.

For example, prior to sending the first request message, the PSE1 may receive first information from at least one of the one or more second path selection network elements of the second domain network, wherein the first information may indicate a presence of the at least one of the one or more second path selection network elements in a radio coverage of the first path selection network element

For example, the first information may indicate any of a first identifier identifying the at least one of the one or more second path selection network elements, a second identifier identifying the second domain network, an IP prefix of network elements of the second domain network, and an address of a second domain network path computation network element.

For example, the PSE1 may send second information to the path computation network element of the first domain network, wherein the second information may indicate the presence of the at least one of the one or more second path selection network elements in the radio coverage of the first path selection network element.

For example, the PSE1 may receive third information from the path computation network element of the first domain network, wherein the third information may indicate one or more links to be set up between the first path selection network element and the one or more second path selection network elements for interconnecting the first domain network with the second domain network

For example, in a case where the first path selection network element is out of coverage of the one or more second path selection network elements, the PSE1 may send fourth information to the path computation network element of the first domain network, wherein the fourth information indicates an absence of connectivity between the first domain network and the second domain network.

In an embodiment, a network element comprising a processor and a transmitter and a receiver (e.g., a transceiver) operatively coupled to the processor is described herein. For example, the processor may be configured to send, to a first network element of a first domain network, a first request message requesting one or more tracks towards a second domain network, the first request message indicating a requested QoS. For example, the processor may be configured to receive, from the first network element, a response message indicating (i) one or more second network elements of the second domain network interconnecting the first domain network with the second domain network, and (ii) a QoS partitioning of the requested QoS to be applied on the first and the second domain networks. For example, the processor may be configured to send to the one or more second network elements of the second domain network, one or more second request messages requesting to set up a communication channel across the first and the second domain networks, the one or more second request messages indicating the QoS partitioning to be monitored on the first and the second domain networks via the communication channel. For example, the processor may be configured to receive from the one or more second network elements of the second domain network, an acknowledgement indicating that the communication channel has been established.

For example, the requested QoS may be partitioned in a first QoS budget and a second QoS budget such that the requested QoS may be satisfied on a condition that the first QoS budget is met on the first domain network and on a condition that the second QoS budget is met on the second domain network.

For example, any of the requested QoS, the first QoS budget and the second QoS budget may comprise at least one QoS metric indicating any of a bounded latency, a guaranteed bandwidth, a bounded jitter, a bounded reliability ratio, and an availability ratio.

For example, the processor may be further configured to receive one or more network management messages comprising network management information to monitor QoS in the first domain network.

For example, the processor may be further configured to perform sub-track selection in the one or more tracks based on the network management information, such that the first QoS budget may be met on the first domain network.

For example, in a case where the first QoS budget is not met on the first domain network, the processor may be further configured to send a third request message to the first network element of the first domain network for requesting the one or more tracks to be recomputed and/or the QoS partitioning to be adjusted.

For example, the processor may be further configured to receive an initial request message from a first WTRU of the first domain network prior to sending the first request message, wherein the initial request message may comprise information requesting connectivity with a second WTRU of the second domain network at the requested QoS.

For example, the processor may be further configured to receive first information from at least one of the one or more second network elements of the second domain network prior to sending the first request message, wherein the first information may indicate a presence of the at least one of the one or more second network elements in a radio coverage of the network element.

For example, the first information may indicate any of a first identifier identifying the at least one of the one or more second network elements, a second identifier identifying the second domain network, and an IP prefix of network elements of the second domain network.

For example, the processor may be further configured to send second information to the first network element of the first domain network, wherein the second information may indicate the presence of the at least one of the one or more second network elements in the radio coverage of the network element.

For example, the processor may be further configured to receive third information from the first network element of the first domain network, wherein the third information may indicate one or more links to be set up between the network element and the one or more second network elements for interconnecting the first domain network with the second domain network.

For example, in a case where the network element is out of coverage of the one or more second network elements, the processor may be further configured to send fourth information to the first network element of the first domain network, wherein the fourth information may indicate an absence of connectivity between the first domain network and the second domain network.

For example, any of the network element and the one or more second network elements may be path selection network elements configured to perform sub-track selection on a per one or more packets basis.

For example, the first network element may be a path computation network element.

In an embodiment, a method may be implemented in a network element. For example, the method may comprise sending to a first network element of a first domain network, a first request message requesting one or more tracks towards a second domain network, the first request message indicating a requested QoS. For example, the method may further comprise receiving, from the first network element, a response message indicating (i) one or more second network elements of the second domain network interconnecting the first domain network with the second domain network, and (ii) a QoS partitioning of the requested QoS to be applied on the first and the second domain networks. For example, the method may further comprise sending to the one or more second network elements of the second domain network, one or more second request messages requesting to set up a communication channel across the first and the second domain networks, the one or more second request messages indicating the QoS partitioning to be monitored on the first and the second domain networks via the communication channel. For example, the method may further comprise receiving from the one or more second network elements of the second domain network, an acknowledgement indicating that the communication channel has been established.

For example, the requested QoS may be partitioned in a first QoS budget and a second QoS budget such that the requested QoS may be satisfied on a condition that the first QoS budget is met on the first domain network and on a condition that the second QoS budget is met on the second domain network.

For example, any of the requested QoS, the first QoS budget and the second QoS budget may comprise at least one QoS metric indicating any of a bounded latency, a guaranteed bandwidth, a bounded jitter, a bounded reliability ratio, and an availability ratio.

For example, the method may further comprise receiving one or more network management messages comprising network management information to monitor QoS in the first domain network.

For example, the method may further comprise performing sub-track selection in the one or more tracks based on the network management information, such that the first QoS budget may be met on the first domain network.

For example, the method may further comprise, in a case where the first QoS budget is not met on the first domain network, sending a third request message to the first network element of the first domain network for requesting the one or more tracks to be recomputed and/or the QoS partitioning to be adjusted.

For example, the method may further comprise receiving an initial request message from a first WTRU of the first domain network prior to sending the first request message, wherein the initial request message may comprise information requesting connectivity with a second WTRU of the second domain network at the requested QoS.

For example, the method may further comprise receiving first information from at least one of the one or more second network elements of the second domain network prior to sending the first request message, wherein the first information may indicate a presence of the at least one of the one or more second network elements in a radio coverage of the network element.

For example, the first information may indicate any of a first identifier identifying the at least one of the one or more second network elements, a second identifier identifying the second domain network, and an IP prefix of network elements of the second domain network.

For example, the method may further comprise sending second information to the first network element of the first domain network, wherein the second information may indicate the presence of the at least one of the one or more second network elements in the radio coverage of the network element.

For example, the method may further comprise receiving third information from the first network element of the first domain network, wherein the third information may indicate one or more links to be set up between the network element and the one or more second network elements for interconnecting the first domain network with the second domain network.

For example, the method may further comprise, in a case where the network element is out of coverage of the one or more second network elements, sending fourth information to the first network element of the first domain network, wherein the fourth information may indicate an absence of connectivity between the first domain network and the second domain network.

For example, any of the network element and the one or more second network elements may be path selection network elements configured to perform sub-track selection on a per one or more packets basis.

For example, the first network element may be a path computation network element.

Any characteristic, variant or embodiment described for a method is compatible with an apparatus device comprising means for processing the disclosed method, with a device comprising circuitry, including any of a transmitter, a receiver, a processor, and a memory, configured to process the disclosed method, with a computer program product comprising program code instructions and with a non-transitory computer-readable storage medium storing program instructions.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A network element comprising a processor and a transmitter and a receiver operatively coupled to the processor, the processor being configured to:
send, to a first network element of a first domain network, a first request message requesting one or more tracks towards a second domain network, the first request message indicating a requested quality of service (QoS);
receive, from the first network element, a response message indicating (i) one or more second network elements of the second domain network interconnecting the first domain network with the second domain network, and (ii) a QoS partitioning of the requested QoS to be applied on the first domain network and the second domain network, wherein the network element of the first domain network and the one or more second network elements of the second domain network are in charge of performing local sub-track selection on a per packet basis;
send, to the one or more second network elements of the second domain network, one or more second request messages requesting to set up one or more communication channels across the first domain network and the second domain network between the network element of the first domain network and the one or more second network elements of the second domain network, the one or more second request messages indicating the QoS partitioning to be monitored on the first domain network and the second domain network via the one or more communication channels; and
receive from the one or more second network elements of the second domain network, an acknowledgement indicating that the one or more communication channels have been established.

2. The network element of claim 1, wherein the requested QoS is partitioned in a first QoS budget and a second QoS budget such that the requested QoS is satisfied on a condition that the first QoS budget is met on the first domain network and on a condition that the second QoS budget is met on the second domain network.

3. The network element of claim 2, wherein any of the requested QoS, the first QoS budget and the second QoS budget comprise at least one QoS metric indicating any of a bounded latency, a guaranteed bandwidth, a bounded jitter, a bounded reliability ratio, and an availability ratio.

4. The network element of claim 1, wherein the processor is further configured to receive one or more network management messages comprising network management information to monitor QoS in the first domain network.

5. The network element of claim 4, wherein the processor is further configured to perform sub-track selection in the one or more tracks based on the network management information, such that a first QoS budget is met on the first domain network.

6. The network element of claim 2, wherein in a case where the first QoS budget is not met on the first domain network, the processor is further configured to send a third request message to the first network element of the first domain network for requesting the one or more tracks to be recomputed and/or the QoS partitioning to be adjusted.

7. The network element of claim 1, wherein the processor is further configured to receive an initial request message from a first wireless transmit/receive unit (WTRU) of the first domain network prior to sending the first request message, wherein the initial request message comprises information requesting connectivity with a second WTRU of the second domain network at the requested QoS.

8. The network element of claim 1, wherein the processor is further configured to receive first information from at least one of the one or more second network elements of the second domain network prior to sending the first request message, wherein the first information indicates a presence of the at least one of the one or more second network elements in a radio coverage of the network element.

9. The network element of claim 8, wherein the first information indicates any of a first identifier identifying the at least one of the one or more second network elements, a second identifier identifying the second domain network, and an internet protocol (IP) prefix of network elements of the second domain network.

10. The network element of claim 8, wherein the processor is further configured to send second information to the first network element of the first domain network, wherein the second information indicates the presence of the at least one of the one or more second network elements in the radio coverage of the network element.

11. The network element of claim 1, wherein the processor is further configured to receive third information from the first network element of the first domain network, wherein the third information indicates one or more links to be set up between the network element and the one or more second network elements for interconnecting the first domain network with the second domain network.

12. The network element of claim 1, wherein, in a case where the network element is out of coverage of the one or more second network elements, the processor is further configured to send fourth information to the first network element of the first domain network wherein the fourth information indicates an absence of connectivity between the first domain network and the second domain network.

13. The network element of claim 1, wherein the network element and the one or more second network elements are path selection network elements configured to perform sub-track selection on a per one or more packets basis.

14. The network element of claim 1, wherein the first network element is a path computation network element.

15. A method, implemented in a network element, the method comprising:
sending, to a first network element of a first domain network, a first request message requesting one or more tracks towards a second domain network, the first request message indicating a requested quality of service (QoS);
receiving, from the first network element, a response message indicating (i) one or more second network elements of the second domain network interconnecting the first domain network with the second domain network, and (ii) a QoS partitioning of the requested QoS to be applied on the first domain network and the second domain network, wherein the network element of the first domain network and the one or more second network elements of the second domain network are in charge of performing local sub-track selection on a per packet basis;
sending, to the one or more second network elements of the second domain network, one or more second request messages requesting to set up one or more communication channels across the first domain network and the second domain network between the network element of the first domain network and the one or more second network elements of the second domain network, the one or more second request messages indicating the QoS partitioning to be monitored on the first domain network and the second domain network via the one or more communication channels; and
receiving from the one or more second network elements of the second domain network, an acknowledgement indicating that the one or more communication channels have been established.

16. The method of claim 15, wherein the requested QoS is partitioned in a first QoS budget and a second QoS budget such that the requested QoS is satisfied on a condition that the first QoS budget is met on the first domain network and on a condition that the second QoS budget is met on the second domain network.

17. The method of claim 16, wherein any of the requested QoS, the first QoS budget and the second QoS budget comprise at least one QoS metric indicating any of a bounded latency, a guaranteed bandwidth, a bounded jitter, a bounded reliability ratio, and an availability ratio.

18. The method of claim 15, further comprising receiving one or more network management messages comprising network management information to monitor QoS in the first domain network.

19. The method of claim 18, further comprising performing sub-track selection in the one or more tracks based on the network management information, such that a first QoS budget is met on the first domain network.

20. The method of claim 16, further comprising, in a case where the first QoS budget is not met on the first domain network, sending a third request message to the first network element of the first domain network for requesting the one or more tracks to be recomputed and/or the QoS partitioning to be adjusted.
